(19) United States
(12) Patent Application Publication
(10) Pub. No.: US 2018/0197479 A1
(43) Pub. Date: Jul. 12, 2018

(54) OLED PWM DIGITAL DRIVING METHOD AND CIRCUIT

(71) Applicant: Shenzhen China Star Optoelectronics Technology Co., Ltd., Shenzhen (CN)

(72) Inventor: Mingfeng Chen, Shenxhen (CN)

(21) Appl. No.: 15/328,524

(22) PCT Filed: Jan. 6, 2017
(86) PCT No.: PCT/CN2017/070445

§ 371 Date: Jul. 7, 2017

(30) Foreign Application Priority Data
Aug. 25, 2016 (CN) 201610717138.2

(51) Int. Cl. G09G 3/3266; G09G 3/20

(52) U.S. Cl. CPC G09G 3/3266; G09G 2310/0205; G09G 2310/0218; G09G 3/2022

(57) ABSTRACT

Disclosed is an OLED PWM digital driving method and circuit, and the method comprises: dividing scanning lines in each sub-field in OLED PWM architecture into a plurality of groups; and performing scanning in the groups at the same time to increase a ratio of pixel lighting time to display time of a frame of image.

### CROSS-REFERENCE TO RELATED APPLICATIONS

The present application claims the priority of Chinese patent application CN201610717138.2, entitled “OLED PWM digital driving method and circuit” and filed on Aug. 25, 2016, the entirety of which is incorporated herein by reference.

### FIELD OF THE INVENTION

The present disclosure belongs to the technical field of organic display control, and in particular, to an OLED PWM digital driving method and a circuit.

### BACKGROUND OF THE INVENTION

An OLED (organic light emitting diode) 3T1C (3 transistors T1, T2 and T3, and 1 capacitance Cst) pixel driving circuit is shown in FIG. 1, wherein D is a data drive signal, G is a charge scanning signal, DG is a discharge scanning signal, ODdd is a constant voltage source, Ovss is an output voltage of an active light emitting diode, and Vref is a reference voltage. There are only two Gamma voltage levels, i.e., GM1 (brightest) and GM9 (darkest) voltage levels, output at V_{A} when the circuit is under digital driving. The following is a current-voltage I-V equation for a transistor:

I_{ds,sat}=k·(V_{GS}−V_{th,T2})²=k·(V_{A}−V_{S}−V_{th,T2})²

wherein I_{ds,sat} is a conduction current of the transistor, k is an intrinsic conduction factor, V_{GS} is a gate-to-source voltage of the transistor, V_{th,T2} is a threshold voltage of transistor T2, V_{A} denotes a voltage at point V_{A}, and V_{S} denotes a voltage at point V_{S}. As variation ΔVth of transistor threshold voltage Vth is relatively smaller than variation of (VA-VS) due to degeneration or non-uniformity of the component, the digital driving mode may inhibits non-uniform brightness of the OLED when compared to an analog driving mode.

When the pixel driving circuit as shown in FIG. 1 operates, transistor T1 charges the circuit and enables the voltage at VA point to be increased, and transistor T3 discharges the circuit and enables the voltage at VA point to be decreased. Thus, VA is finally controlled to output only two Gamma voltage levels and output gray-scales by means of PWM (Pulse-Width Modulation).

FIG. 2 schematically shows driving of 6 sub-fields (indicating 6 bits) and 1280 scanning lines under the architecture of FIG. 1. By controlling the length of charge time of a sub-field SF in conjunction with the principle that human eye's perception of brightness is temporal integration, digital voltages (i.e., two Gamma voltages) can be used to display images of different gray-scales and brightness.

A schematic diagram of OLED PWM analogy driving in the prior art is shown in FIG. 3, wherein x axis represents time, y axis represents scanning time of scanning lines, Tch is time of scanning a full frame of image, and light fill color represents pixel lighting time. As there is no need in analogy driving to discharge the circuit and decrease a pixel drive voltage, pixel lighting time is nearly 100%.

However, in the OLED PWM digital driving method for 6-bit driving as shown in FIG. 2, sub-fields are lit in a time sequence of bit0, bit1, bit2, bit3, bit4 and bit5, and are driven in a weight sequence of 1:2:4:8:16:32. In FIG. 2, slash 1 represents a charging process for pixels, Tch represents time of charging pixels of a full image in a sub-field, slash 2 represents a discharging process for pixels, and Tdch represents time of discharging a full pixel in a sub-field.

It can be appreciated through comparison of the schematic diagrams of digital driving and analogy driving that a ratio of pixel lighting time to display time of an entire frame of image in digital driving is much less than that in analogy driving, resulting in low brightness of digital driving being perceived by human eyes.

### SUMMARY OF THE INVENTION

In order to solve the above problems, the present disclosure provides an OLED PWM digital driving method and circuit to increase brightness of an image perceived by human eyes during PWM digital driving.

According to one aspect of the present disclosure, an OLED PWM digital driving method is provided. The method comprises:

dividing scanning lines in each sub-field in an OLED PWM architecture into a plurality of groups; and

performing scanning in the groups at the same time to increase a ratio of pixel lighting time to display time of a frame of image.

According to one embodiment of the present disclosure, the groups of scanning lines in each sub-field comprise an equal number of scanning lines.

According to one embodiment of the present disclosure, the groups of scanning lines in each sub-field comprise different numbers of scanning lines.

According to one embodiment of the present disclosure, among the groups of scanning lines in each sub-field, scanning is performed at the same time, and scanning in each group is performed in a predetermined sequence.

According to one embodiment of the present disclosure, the scanning lines of each sub-field are divided into a plurality of groups with scanning in the groups performed at the same time, and more sub-fields are drivable in a frame of image at the premise of ensuring a constant driving time.

According to another aspect of the present disclosure, an OLED PWM digital driving circuit is provided. The circuit comprises:

a plurality of scanning lines for outputting scanning signals, wherein

the plurality of scanning lines in each sub-field are divided into a plurality of groups, and scanning in the groups is performed at the same time to increase a ratio of pixel lighting time to display time of a frame of image.

According to one embodiment of the present disclosure, the groups of scanning lines in each sub-field comprise an equal number of scanning lines.

According to one embodiment of the present disclosure, the groups of scanning lines in each sub-field comprise different numbers of scanning lines.

According to one embodiment of the present disclosure, among the groups of scanning lines in each sub-field, scanning is performed at the same time, and scanning in each group is performed in a predetermined sequence.

According to one embodiment of the present disclosure, the scanning lines of each sub-field are divided into a plurality of groups with scanning in the groups performed at the same time, and more sub-fields are drivable in a frame of image at the premise of ensuring constant driving time.

The present disclosure has the following advantages.

By dividing the scanning lines in each sub-field into a plurality of groups and driving the groups of scanning lines at the same time, it is possible to increase the ratio of pixel lighting time to the display time of a frame, such that scanning time is shortened, more sub-fields are present in one frame and image display quality is improved.

Other advantages, objectives and features of the present disclosure will be partly explained in the following description and will be partly apparent to those skilled in the art based on investigation study of the following, or teachings may be provided from the practice of the present disclosure. Objectives and other advantages of the present disclosure may be realized and achieved through the structure specifically pointed out in the following description, claims, and the accompanying drawings.

### BRIEF DESCRIPTION OF THE DRAWINGS

The drawings are provided for further understanding of the technical solutions of the application or the prior art, and constitute one part of the description, wherein the drawings presenting embodiments of the application, in conjunction with the embodiments of the application, serve to explain the technical solutions of the application, rather than to limit the technical solutions of the application. In the drawings:

FIG. 1 schematically shows an OLED 3TIC pixel driving circuit in the prior art;

FIG. 2 schematically shows a 6-sub-field PWM digital driving in correspondence with FIG. 1;

FIG. 3 schematically shows an OLED PWM analogy driving in the prior art;

FIG. 4 is a flow diagram showing a method according to one embodiment of the present disclosure;

FIG. 5 schematically shows OLED PWM 2-group scanning driving according to one embodiment of the present disclosure; and

FIG. 6 schematically shows OLED PWM 4-group scanning driving according to one embodiment of the present disclosure.

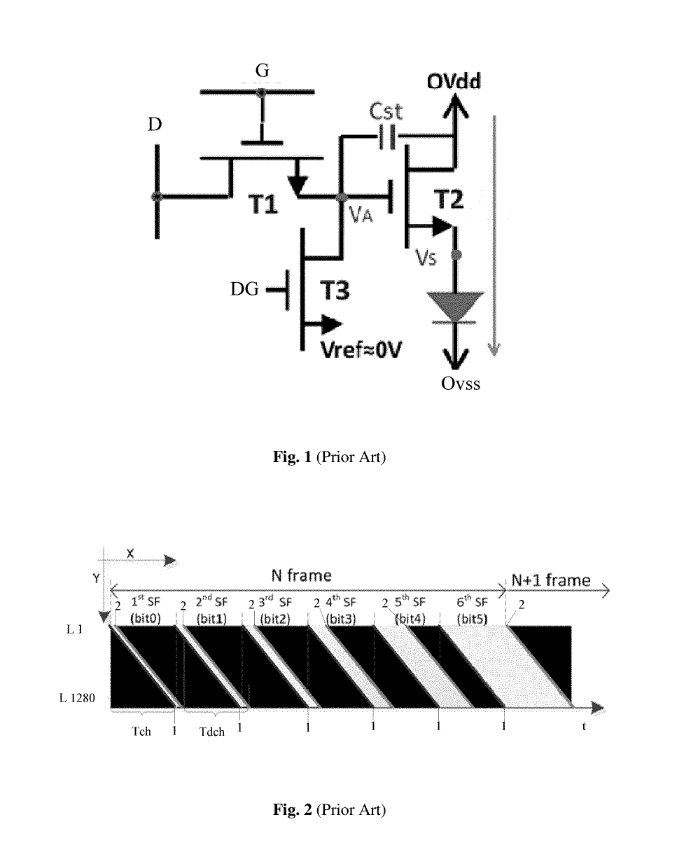

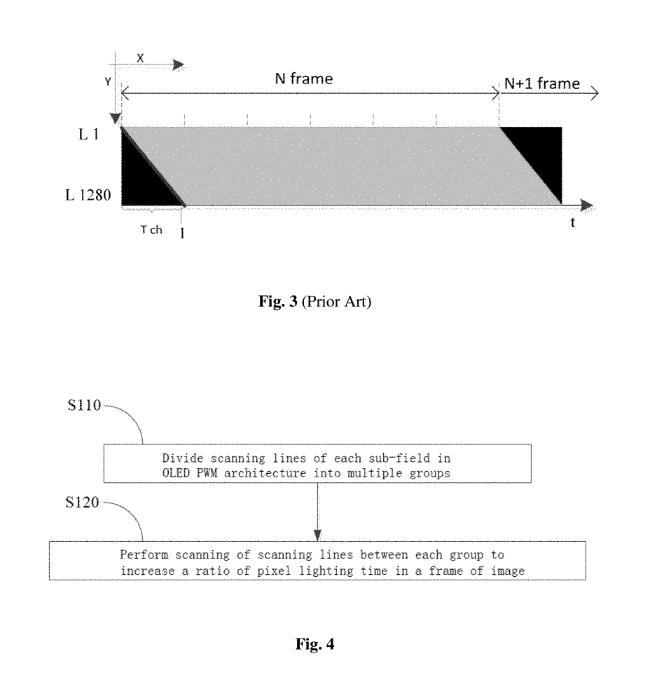

### DETAILED DESCRIPTION OF THE EMBODIMENTS

The embodiments of the present disclosure will be explained below in connection with the accompanying drawings and embodiments, whereby the implementing process, i.e., how the present disclosure applies technical means to solve the technical problem and achieve corresponding technical effects, may be fully appreciated and thereby practiced. The embodiments of the application and various features in the embodiments may be combined with one another at the premise of avoiding conflicting, and all the formed technical schemes fall in the scope of the present disclosure.

In order to solve the problem that a ratio of pixel lighting time to display time of a whole frame in a digital driving method is much less than that in analogy driving and the problem that brightness in digital driving perceived by human eyes is low, the present disclosure provides an OLED PWM digital driving method to solve the problem that brightness in digital driving is low, and to improve image display quality. FIG. 4 shows a flow diagram of the method according to one embodiment of the present disclosure, and the present disclosure is explained below in detail with reference to FIG. 4.

As shown in FIG. 4, firstly in step S110, scanning lines in each sub-field in OLED PWM architecture are divided into a plurality of groups; and then in step S120, scanning in different groups is performed at the same time to increase the ratio of pixel lighting time to display time of an entire frame of image. Particularly, the plurality of scanning lines in each sub-field is divided into a plurality of groups, with the number of the groups much less than the number of the scanning lines. If scanning in different groups is performed at the same time, scanning time for one sub-field is only about the time required for scanning for one group. By performing scanning in different groups at the same time, pixels that traditionally are not simultaneously lit are lit at the same time, by way of which image display brightness is improved. In addition, in the case of constant scanning driving time for a frame of image, lighting time of pixels in a frame of image is extended, and image display quality is thus improved.

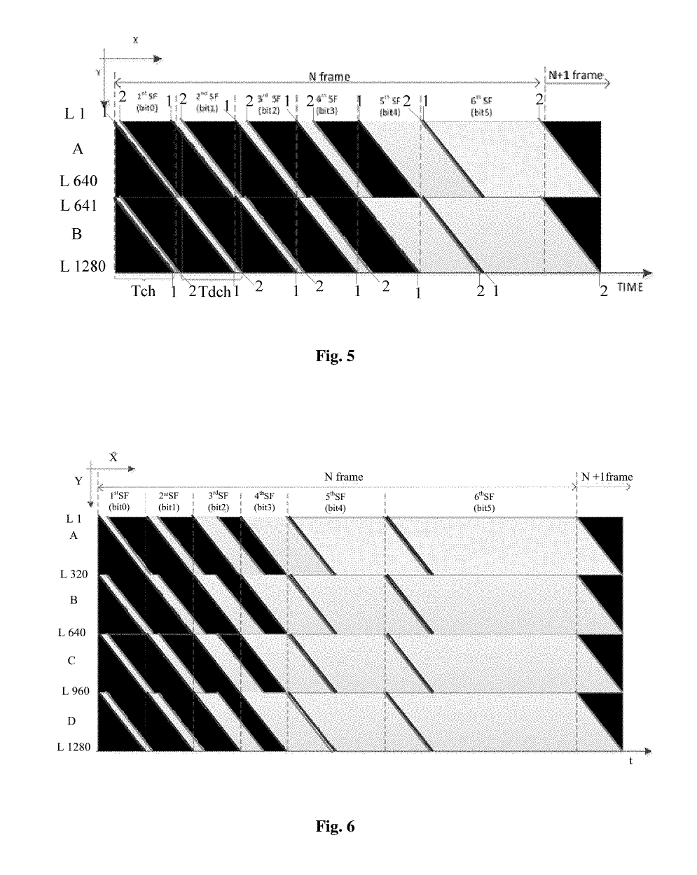

According to one embodiment of the present disclosure, the groups of scanning lines in the sub-fields comprise an equal number of scanning lines. Particularly, as shown in FIG. 5, an OLED PWM architecture with a frame of image cut into 6 sub-fields corresponding to bit0 to bit5 and having a resolution of 720*1280 is explained as an example, practices are similar if more sub-fields are used. The present disclosure is not limited to the number, weights, and weight distribution of the sub-fields and is applicable to all similar digital driving modes.

In the embodiment, the scanning lines are equally divided into groups A and B to drive the sub-fields. The group A comprises scanning lines L1 to L640, and the group B comprises scanning lines L641 to L1280. The groups A and B are driven at the same time. If the 6 sub-fields are driven in an order of the least to the largest weight, i.e., bit0:bit1:bit2:bit3:bit4:bit5=1:2:4:8:16:32, then as is traditionally implemented (e.g., the driving mode as shown in FIG. 2), assuming one sub-field is displayed for 32 t (t representing a time unit), a ratio of pixel turn-on time to display time of the whole frame is (1+2+4+8+16+32)/(32*6)=32.81%, and time for displaying the whole frame of image comprising the 6 sub-fields is 192 t.

According to the driving method as shown in FIG. 5, each sub-field is driven the groups A and B, and the ratio of pixel turn-on time to the display time of the whole frame is (1+2+4+8+16+32)/(16*7)=56.25%. Time for displaying the whole frame comprising the 6 sub-fields is 112 t. In one frame, the pixel turn-on time is increased, and therefore the brightness is improved. As the time for each sub-field is shortened, sub-fields with larger weight in one frame can be controlled, whereby image display quality can be improved.

If the scanning lines in one sub-field are divided into more groups, the ratio of pixel lighting time to the display time of the entire frame of image is larger. As shown in FIG. 6, the scanning lines in a sub-field are divided into four groups A, B, C and D for driving at the same time, the group A including L1 to L320, the group B including L321 to L640, the group C including L641 to L960, and the group D including L961 to L1280. Then, the ratio of brightness may reach 78.75%, and time for scanning the 6 sub-fields is 80 t. The image brightness ratio is increased, and the time for scanning the 6 sub-fields is shortened, such that more gray-scales of sub-fields are driven and image display quality is improved.

The above embodiments show the driving mode where the groups of scanning lines in the sub-pixels comprise an equal number of scanning lines. It is also possible to implement similar driving of FIG. 5 when the groups of scanning lines in the sub-fields include different number of scanning lines, and it is only to be noted that the groups are different in driving time. In driving the scanning lines in different groups, driving of the scanning lines in each group may be proceeded in a predetermined sequence, which may be both positive and reverse or may be other sequences.

In one embodiment of the present disclosure, the scanning lines of each sub-field are divided into a plurality of groups and scanning in different groups is performed at the same time. More sub-fields are drivable in a frame of image at the premise of ensuring constant driving time. For example, the above shows the driving of 6 sub-fields divided in one frame and driven according to the weights 1:2:4:8:16:32. The traditional method as shown in FIG. 2 takes 192 t to scan the 6 sub-fields. In FIG. 5, the scanning lines in a sub-field are divided into 2 groups for driving, and the time for scanning the 6 sub-fields is 112t. When the scanning lines are divided into 4 groups as shown in FIG. 6, time for scanning the 6 sub-fields is 80t. As can be seen, by dividing scanning lines into more groups, driving time is shortened and more sub-fields is driven in one frame, whereby image quality is increased from 6 sub-fields of FIGS. 5 to 8 sub-fields of FIG. 6 or to more sub-fields, such that display effect is promoted.

According to another aspect of the present disclosure, an OLED PWM digital driving circuit is provided. The driving circuit comprises: a plurality of scanning lines for outputting scanning signals, wherein a plurality of scanning lines in each sub-field is divided into a plurality of groups, and scanning in the plurality of groups is performed at the same time to increase a ratio of pixel lighting time to display time of a frame of image. Scanning time for each scanning line may be implemented by modifying a control signal output by an existing digital driving module.

According to one embodiment of the present disclosure, the groups of scanning lines in each sub-field comprise an equal number of scanning lines.

According to one embodiment of the present disclosure, the groups of scanning lines in each sub-field comprise different number of scanning lines.

According to one embodiment of the present disclosure, scanning in different groups of scanning lines in each sub-field is performed at the same time, and scanning in each group is performed in a predetermined sequence.

According to one embodiment of the present disclosure, scanning lines of each sub-field are divided into a plurality of groups and scanning in different groups is performed at the same time, and more sub-fields are drivable in a frame of image at the premise of ensuring constant driving time.

By dividing the scanning lines of each sub-field into a plurality of groups and driving the groups of scanning lines at the same time, it is possible to increase the ratio of pixel lighting time to display time of an entire frame, such that scanning time is shortened, more sub-fields are present in one frame and image display quality is improved.

The above description should not be construed as limitations of the present disclosure, but merely as exemplifications of preferred embodiments thereof. Any variations or replacements that can be readily envisioned by those skilled in the art are intended to be within the scope of the present disclosure. Hence, the scope of the present disclosure should be subject to the scope defined in the claims.

1. An OLED PWM digital driving method, comprising:
dividing scanning lines in each sub-field in an OLED PWM architecture into a plurality of groups; and
performing scanning in the groups at the same time to increase a ratio of pixel lighting time to display time of a frame of image.

2. The method according to claim 1, wherein the groups of scanning lines in each sub-field comprise an equal number of scanning lines.

3. The method according to claim 1, wherein the groups of scanning lines in each sub-field comprise different numbers of scanning lines.

4. The method according to claim 2, wherein, among the groups of scanning lines in each sub-field, scanning is performed at the same time, and scanning in each group is performed in a predetermined sequence.

5. The method according to claim 3, wherein, among the groups of scanning lines in each sub-field, scanning is performed at the same time, and scanning in each group is performed in a predetermined sequence.

6. The method according to claim 4, wherein the scanning lines of each sub-field are divided into a plurality of groups with scanning in the groups performed at the same time, and more sub-fields are drivable in a frame of image at the premise of ensuring a constant driving time.

7. The method according to claim 5, wherein the scanning lines of each sub-field are divided into a plurality of groups with scanning in the groups performed at the same time, and more sub-fields are drivable in a frame of image at the premise of a constant driving time.

8. An OLED PWM digital driving circuit, comprising:
a plurality of scanning lines for outputting scanning signals,
wherein the plurality of scanning lines in each sub-field are divided into a plurality of groups, and scanning in the groups is performed at the same time to increase a ratio of pixel lighting time to display time of a frame of image.

9. The circuit according to claim 8, wherein the groups of scanning lines in each sub-field comprise an equal number of scanning lines.

10. The circuit according to claim 8, wherein the groups of scanning lines in each sub-field comprise different numbers of scanning lines.

11. The circuit according to claim 9, wherein, among the groups of scanning lines in each sub-field, scanning is performed at the same time, and scanning in each group is performed in a predetermined sequence.

12. The circuit according to claim 10, wherein, among the groups of scanning lines in each sub-field, scanning is performed at the same time, and scanning in each group is performed in a predetermined sequence.

13. The circuit according to claim 11, wherein the scanning lines of each sub-field are divided into a plurality of groups with scanning in the groups performed at the same time, and more sub-fields are drivable in a frame of image at the premise of ensuring a constant driving time.

14. The circuit according to claim 12, wherein the scanning lines of each sub-field are divided into a plurality of groups with scanning in the groups performed at the same time, and more sub-fields are drivable in a frame of image at the premise of ensuring a constant driving time.
